(19) United States
(12) Patent Application Publication
(10) Pub. No.: US 2026/0113192 A1
(43) Pub. Date: Apr. 23, 2026

(54) System and Method for Generating and Validating Time-Based Dynamic Authentication Tokens Using a Time-Slicing Approach

(71) Applicants: Upendra Kumar Jariya, Indore (IN); Arvinder Singh Chhabra, Indore (IN); Bharti Tatwade, Indore (IN)

(72) Inventors: Upendra Kumar Jariya, Indore (IN); Arvinder Singh Chhabra, Indore (IN); Bharti Tatwade, Indore (IN)

(21) Appl. No.: 19/021,523

(22) Filed: Jan. 15, 2025

(30) Foreign Application Priority Data
Oct. 19, 2024 (IN) 202421079548

(51) Int. Cl. H04L 9/32

(52) U.S. Cl. CPC H04L 9/3213; H04L 9/3242

(57) ABSTRACT

The present invention relates to a system for generating and validating time-based dynamic authentication tokens for stateless client-server communication. The system comprises a client device that generates a unique authentication token for each request, including a user identifier, device identifier, request identifier, and time slice identifier corresponding to a portion of a time slot divided into slices. The client device transmits the token with the request to a server, that includes a time server to synchronize the server and client time. A token validation module verifies whether the time slice identifier belongs to the current or previous time slice within the same time slot and validates the token by reconstructing it based on the identifiers. The server rejects requests if the token is generated outside the valid time slice or does not match the reconstructed token, providing enhanced security.

### CROSS-REFERENCES TO RELATED APPLICATIONS

This Non-Provisional Patent Application claims the benefit of and priority to Indian Patent Application Serial No. 202421079548, filed Oct. 19, 2024, entitled “System and Method for Generating and Validating Time-Based Dynamic Authentication Tokens Using a Time-Slicing Approach,” the entire contents of which is hereby incorporated herein by reference.

### FIELD OF THE INVENTION

The invention relates generally to network-based communications between a client and a server, and more particularly to a system and a method for generating and validating time-based dynamic authentication tokens using a time-slicing approach for stateless client-server communication.

### BACKGROUND

The subject matter discussed in the background section should not be assumed to be prior art merely as a result of it being mentioned in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Software is often organized to run on distributed systems (multiple computing devices interconnected by a network) by implementing a client-server model. In a client-server model, a client application is executed on a first, client device, and a server application is executed on a second, server device. The server application/device provides services that are used by the client application/device. It is desirable for communications between networked client and server devices to be secured, so that the services provided by the server can be obtained only by client devices that are authorized to receive the services. It is therefore necessary to ensure proper authentication and or authorization of the client to obtain the services.

As client-server architectures evolved, early systems relied heavily on stateful APIs to manage user sessions. These stateful implementations allowed servers to track the activities of individual users, which greatly reduced the risk of unauthorized access or security breaches. However, as user bases expanded and the need for scalability grew, stateful systems faced significant limitations. Servers could only support a finite number of concurrent users, and sharing session information across multiple servers proved to be inefficient and challenging. As a result, most organizations transitioned away from stateful server-side implementations in favor of stateless architectures like REST and GraphQL APIs.

In stateless communication systems, particularly those using REST APIs, scaling became much easier. Servers no longer had to manage individual user sessions, allowing them to handle millions of concurrent users with relative ease. By adding CPU and RAM, organizations could scale server capacity without the complexity of managing user states. Stateless APIs rely on tokens such as JSON Web Tokens (JWT) to authenticate users for a defined period. These tokens allow users to access resources without maintaining a continuous connection to the server, making it a preferred method for many organizations, including those handling financial transactions.

Despite the advantages of stateless architectures, they have introduced significant vulnerabilities. One major issue is that tokens, such as JWTs, are often reused across multiple requests during their valid period. If a token is copied or hacked, it can be misused to make unauthorized requests, sometimes from entirely different devices or applications. Servers today struggle to detect when the same token is being used simultaneously across multiple devices, leading to potential security breaches. Additionally, if a token is stored insecurely, such as in browser cookies, it becomes a target for attackers, further exacerbating the security risk.

In light of these challenges, there is a critical need for a more secure, dynamic, and time-sensitive token generation method to address the shortcomings of current stateless API systems. Existing solutions fail to prevent unauthorized use of tokens across devices and do not ensure that tokens are tied to specific requests or time frames. The increasing frequency of attacks exploiting static tokens highlights the necessity of an improved approach to authentication and validation, ensuring better protection for sensitive transactions and preventing misuse of access tokens.

### SUMMARY

According to one aspect of the invention, there is provided a system for generating and validating time-based dynamic authentication tokens using a time-slicing approach for stateless client-server communication. The system comprises a client device configured to generate a unique authentication token for each request, where the token includes, but is not limited to, a user identifier representing the identity of the user, a device identifier uniquely identifying the client device, a request identifier uniquely identifying the request, and a time slice identifier corresponding to a portion of a predetermined time slot divided into multiple slices. The client device transmits the authentication token along with the request during a valid time slice.

The system further comprises a server connected to the client device via a network, and a time server that synchronizes the time between the client device and the server, ensuring the time difference between the current time on the client device and the server does not exceed a predetermined time limit. The server comprises a token validation module that receives the request and the authentication token from the client device, determines whether the time slice identifier belongs to the current or previous time slice within the same time slot or falls within a predefined consideration window, and validates the authentication token by reconstructing the token using the user identifier, device identifier, request identifier, and time slice identifier. If the authentication token is generated outside the valid time slice or does not match the reconstructed token, the server rejects the request; otherwise, it processes the request, thereby providing enhanced security for stateless communication and non-repudiation.

In accordance with an embodiment of the present invention, the synchronization between the client device and the server ensures that the difference between the Unix time on both devices does not exceed 50 to 200 milliseconds.

In accordance with an embodiment of the present invention, the predetermined time slot duration is between 500 to 300000 milliseconds.

In accordance with an embodiment of the present invention, the predetermined time slot is divided into 2 to 10 time slices, with each slice having a duration between 100 to 75000 milliseconds.

In accordance with an embodiment of the present invention, the authentication token generated for a request is valid only within the predetermined time slot and expires upon the completion of the time slot.

In accordance with an embodiment of the present invention, the token validation module allows tokens generated in the previous time slots if they fall within a predefined consideration window of 1 to (n−1) time slices, where ‘n’ is the number of slices in one slot.

In accordance with an embodiment of the present invention, the time slot is divided into exactly 4 slices, and the token validation module validates tokens using a 4-slice window, allowing tokens from any of the slices in the current or previous time slot within the consideration window.

In accordance with an embodiment of the present invention, the token validation module validates tokens by accepting those generated in slice 1 (S1) within the current time slot in slices 1 through 4 (S1, S2, S3, S4) of the current time slot on the server side; validates tokens generated in slice 2 (S2) within slices 2 through 4 of the current time slot and slice 1 of the next time slot; and validates tokens generated in slice 3 (S3) within slices 3 and 4 of the current time slot and slice 1 and 2 of the next time slot.

In accordance with an embodiment of the present invention, the authentication token comprises a hash-based message authentication code (HMAC) or equivalent, generated by a token generator using any one or more of the user identifier, device identifier, request identifier, time slice identifier, and a static or dynamic secret key.

In accordance with an embodiment of the present invention, the server validates the HMAC token by comparing the user identifier, device identifier, request identifier, and time slice identifier with the secret key.

According to a second aspect of the present invention, there is provided a method for generating and validating time-based dynamic authentication tokens using a time-slicing approach for stateless client-server communication comprises generating a unique authentication token for each request on a client device, wherein the token includes, but is not limited to, a user identifier, a device identifier, a request identifier, and a time slice identifier corresponding to a portion of a predetermined time slot divided into multiple slices. The method further comprises transmitting the authentication token along with the request to a server, synchronizing the time between the client device and the server to ensure that the difference in time does not exceed a predetermined limit, determining whether the time slice identifier belongs to the current or previous time slice within the same time slot or falls within a predefined consideration window, validating the authentication token by reconstructing the token using the user identifier, device identifier, request identifier, and time slice identifier, and rejecting or processing the request based on whether the token matches the reconstructed token.

In accordance with an embodiment of the present invention, the synchronization between the client device and the server ensures that the difference in Unix time between both devices does not exceed 50 to 200 milliseconds.

In accordance with an embodiment of the present invention, the time slot duration is predetermined to be between 500 to 300000 milliseconds.

In accordance with an embodiment of the present invention, the predetermined time slot is divided into 2 to 10 time slices, with each slice having a duration between 100 to 75000 milliseconds.

In accordance with an embodiment of the present invention, the authentication token is valid only within the predetermined time slot and expires upon the completion of the time slot.

In accordance with an embodiment of the present invention, the server validates tokens generated in the previous time slices if they fall within a predefined consideration window of 1 to (n−1) time slices, where ‘n’ is the number of slices in one slot.

In accordance with an embodiment of the present invention, the time slot is divided into exactly 4 slices, and the server validates tokens using a 4-slice window, allowing tokens from any of the slices in the current or previous time slot within the consideration window.

In accordance with an embodiment of the present invention, the method further comprises validating tokens generated in slice 1 (S1) within the current time slot in slices 1 through 4 (S1, S2, S3, S4) of the current time slot; validating tokens generated in slice 2 (S2) within slices 2 through 4 of the current time slot and slice 1 of the next time slot; and validating tokens generated in slice 3 (S3) within slices 3 and 4 of the current time slot and slice 1 and 2 of the next time slot.

In accordance with an embodiment of the present invention, the authentication token is generated using a hash-based message authentication code (HMAC) or equivalent, based on the user identifier, device identifier, request identifier, time slice identifier, and a secret key.

In accordance with an embodiment of the present invention, the method further includes validating the HMAC token on the server by comparing the user identifier, device identifier, request identifier, and time slice identifier with the secret key.

In accordance with another aspect of the invention, there is provided a system for detecting cloned devices in a client-server network. The system comprises a client device configured to generate a unique request identifier for each request sent to a server, a client-side ordered list of request identifiers corresponding to a predefined number of previously sent requests, and a server configured to receive the requests from the client device. The server stores an ordered list of request identifiers corresponding to the requests received from the client device, and the server compares the sequence of request identifiers in the client's request with the sequence stored on the server. The session is terminated if a mismatch is detected, thereby identifying potential cloned devices.

In accordance with an embodiment of the present invention, the client device is configured to generate and send the list of request identifiers, including the current request identifier, during each request to the server.

In accordance with an embodiment of the present invention, the system further comprises a keep-alive API, wherein the client device is configured to periodically invoke the keep-alive API with a unique request identifier to indicate session activity, and the server terminates the session if the request identifiers are mismatched.

In accordance with an embodiment of the present invention, the client-side list of request identifiers is updated before each request is sent to the server, and the server-side list is updated accordingly upon receipt of valid requests.

In accordance with an embodiment of the present invention, the server is configured to implement a policy that either rejects or conditionally accepts requests from a client device that has been detected as a potential clone.

In accordance with yet another aspect of the invention, there is provided a method for detecting cloned devices in a client-server communication system. The method comprises generating, on a client device, a unique request identifier for each request sent to a server, maintaining, on the client device, an ordered list of request identifiers corresponding to a predefined number of previously sent requests, transmitting the current request identifier along with the list of previously generated request identifiers to the server, comparing, by the server, the received request identifier sequence with a stored list of request identifiers on the server, and terminating the session if the sequence of request identifiers does not match, thereby detecting potential cloned devices.

In accordance with an embodiment of the present invention, the method further includes updating the client-side list of request identifiers before sending each request to the server.

In accordance with an embodiment of the present invention, the server maintains a list of previously received request identifiers corresponding to each client device and checks the sequence for consistency with the current request.

In accordance with an embodiment of the present invention, the method further includes invoking a keep-alive API on the server, wherein the client device periodically sends the request identifier to the server, and the server terminates the session if the client device fails to send the keep-alive request within a predefined time window.

In accordance with an embodiment of the present invention, the method further includes logging the mismatch event and reporting it to an intrusion detection system for further action.

In accordance with yet another aspect of the invention, there is provided a method for detecting automated scripts on a server side. The method comprises establishing a list of API identifiers corresponding to previously invoked APIs by a client application, detecting the current API being invoked from an incoming request, updating the list of API identifiers corresponding to the current user to include the API being invoked by the current request, establishing a list of timestamps corresponding to past API invocations by the client application, obtaining the timestamp of the current API invocation from the incoming request, updating the list of timestamps for the current user to include the timestamp of the current API invocation, verifying that the order of API invocations follows a predetermined sequence, and verifying that the time gap between API invocations meets a predetermined minimum threshold to detect and prevent automated scripts.

In accordance with an embodiment of the present invention, the list of API identifiers is stored in cache memory corresponding to each client, and the timestamps are updated upon each request.

In accordance with an embodiment of the present invention, the method further comprises rejecting the request and terminating the session if the order of API invocation is incorrect as per the predefined sequence of APIs required to be invoked.

In accordance with an embodiment of the present invention, the method further comprises rejecting the request and terminating the session if the time gap between API invocations is less than the minimum required threshold.

In accordance with an embodiment of the present invention, the predefined sequence of API invocations and the minimum time gap between API invocations are configured based on the sensitivity and importance of the APIs being invoked.

### BRIEF DESCRIPTION OF THE DRAWINGS

So that how the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, the invention may admit to other equally effective embodiments. These and other features, benefits, and advantages of the present invention will become apparent by reference to the following text figure, with like reference numbers referring to like structures across the views, wherein:

FIG. 1 illustrates a system for generating and validating time-based dynamic authentication tokens using a time-slicing approach for stateless client-server communication, in accordance with an embodiment of the present invention;

FIG. 2 illustrates a method for generating and validating time-based dynamic authentication tokens using a time-slicing approach for stateless client-server communication, in accordance with an embodiment of the present invention;

FIGS. 3A-3D illustrates exemplary scenarios considering 4 slices in each time slot and a consideration window of 1 slice, in accordance with an embodiment of the present invention;

FIGS. 4A-4F illustrates exemplary scenarios considering 4 slices in each time slot and a consideration window of 3 slices, in accordance with an embodiment of the present invention; and

FIG. 5 illustrates an exemplary information flow of the system of FIG. 1 to detect device cloning, in accordance with an embodiment of the present invention.

### DETAILED DESCRIPTION

While the present invention is described herein by way of example using embodiments and illustrative drawings, those skilled in the art will recognize that the invention is not limited to the embodiments of drawing or drawings described and is not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed. Still, on the contrary, the invention is to cover all modifications, equivalents, and alternatives falling within the scope of the present invention as defined by the appended claims. As used throughout this description, the word “may” is used in a permissive sense (i.e., meaning having the potential to), rather than the mandatory sense, (i.e., meaning must). Further, the words “a” or “an” mean “at least one” and the word “plurality” means “one or more” unless otherwise mentioned. Furthermore, the terminology and phraseology used herein are solely used for descriptive purposes and should not be construed as limiting in scope. Language such as “including,” “comprising,” “having,” “containing,” or “involving,” and variations thereof, is intended to be broad and encompass the subject matter listed after that, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles, and the like is included in the specification solely to provide a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element, or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

The present invention generally relates to a time-synchronized security system for generating and validating dynamic authentication tokens in stateless client-server or peer-to-peer communications. In each request, the client device generates a dynamic token that incorporates several essential components: the user's identity, device identifier, request identifier, and time slice identifier. This token is securely transmitted to the server as part of the authentication process. Upon receiving the request, the server validates the token by reconstructing it using synchronized time data and comparing it to the token sent by the client. The system ensures that tokens are valid for a very short, predefined time window, preventing reuse of tokens in future requests or across different devices.

To address challenges with token expiration at time slot boundaries, the present invention introduces a method of slicing time slots into smaller, predefined time slices. This allows for more precise validation of requests by considering both current and previous time slots within a predefined consideration window. The server evaluates the time slice identifier and determines whether the request should be allowed based on the time synchronization between the client and server. If the request's creation time falls within the valid time window and matches the reconstructed token, the server processes the request. Otherwise, the request is rejected, providing a robust defense against token misuse and replay attacks.

The system also enhances security by ensuring that each request is uniquely tied to the user and device, with no possibility of token reuse. Additionally, by splitting time slots into slices, the invention minimizes the impact of minor time discrepancies between the client and server, reducing the need for manual intervention and enabling seamless, automated request handling while maintaining high levels of security.

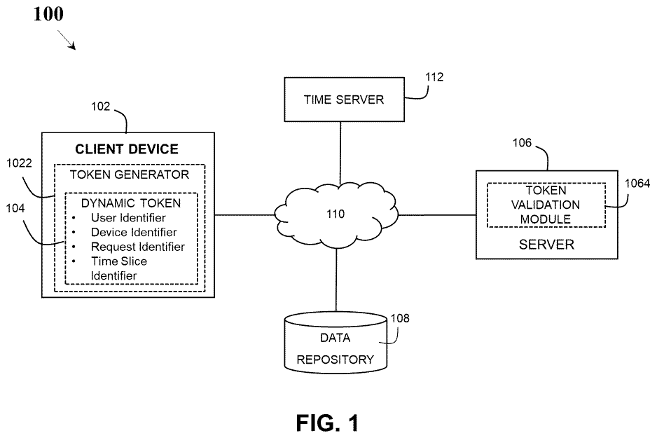

In the accompanying drawings, FIG. 1 illustrates a system (100) for generating and validating time-based dynamic authentication tokens using a time-slicing approach for stateless client-server communication, in accordance with an embodiment of the present invention. In some embodiments of the present invention, the system architecture, as depicted in FIG. 1, involves a secure, stateless client-server communication model using time-synchronized dynamic tokens for authentication. This system (100) ensures that each request is uniquely authenticated, allowing for secure interaction between client (102) and server (106). The architecture is designed to operate across various platforms, including mobile applications, web applications, and browser-based applications, ensuring broad applicability and seamless integration into different networked environments.

The client device (102) can be any computing device capable of executing the necessary instructions for generating and transmitting requests to the server (106). Examples of client devices include smartphones, desktop computers, laptops, tablets, and browser-based applications. The client device contains a token generator (1022) that is responsible for generating the dynamic token (104) for each request. This dynamic token consists of multiple essential components, such as the user identifier, device identifier, request identifier, and time slice identifier. The user identifier uniquely identifies the user making the request, while the device identifier ensures that the request originates from a specific, pre-authorized device, such as a mobile phone or computer. The request identifier is generated uniquely for each request, ensuring that no two requests are the same, and the time slice identifier reflects the specific time slice within a larger time slot when the request was generated. This guarantees that tokens are time-sensitive and valid only for a short, predefined window.

Once the dynamic token is generated on the client device, it is transmitted to the server (106) over a network (110). The network (110) may include wired or wireless communication systems, such as the Internet, local area networks (LANs), wide area networks (WANs), or mobile communication networks. The network facilitates reliable and secure communication between the client and server by using encryption protocols like Transport Layer Security (TLS) to protect data in transit from interception or tampering.

On the server side, the server (106) is designed to handle request validation and processing. The server may consist of various hardware components, including a central processing unit (CPU), random access memory (RAM), and storage devices such as hard drives (HD) or solid-state drives (SSD), which collectively support the server's operations. The server (106) is also equipped with 112a token validation module (1064).

The token validation module (1064) is responsible for validating the token received from the client. Upon receiving the request and its accompanying dynamic token, the token validation module reconstructs the token using the same parameters—user identifier, device identifier, request identifier, and time slice identifier—that were used by the client. The server (106) then compares the reconstructed token with the token sent by the client to determine whether the request is valid. If the tokens match and the request is within the allowed time slice, the server processes the request. If the token fails validation, or if the request falls outside the valid time slice, the server (106) rejects the request, ensuring that only legitimate, time-bound requests are accepted.

The system (100) further includes a time server (112) that functions to synchronize the time between the client device (102) and the server (106). The time server (112) may be implemented as an independent server, responsible for ensuring precise time synchronization across multiple devices in the network (110), or may be integrated as a module within the server (106). The time server (112) ensures that the time difference between the client device (102) and server (106) does not exceed a predefined limit, typically in the range of 50 to 200 milliseconds, which is critical for validating the time-sliced dynamic authentication tokens. This architecture allows flexibility in deployment, where the time server (112) can either be a separate infrastructure component, similar to public time synchronization services (e.g., NIST's Internet Time Service), or be embedded within the server (106) to maintain accurate time synchronization internally, facilitating secure stateless client-server communication.

In addition to these core components, the system includes a data repository (108) connected to the server (106). The data repository (108) stores critical information, such as user-specific secret keys, device identifiers, request logs, and other relevant metadata required for token generation and validation. The data repository (108) allows the server to quickly retrieve credentials and authentication data in real time during the token validation process. It can also store historical data on prior requests for auditing purposes, improving the system's overall resilience and compliance with security protocols.

The server (106) hardware architecture further includes components like multiple processing cores, non-volatile memory for data storage, and input/output (I/O) interfaces for managing communication with both the network and internal components. The server (106) may operate in a distributed computing environment, where processing tasks are shared across multiple machines, enabling the system to handle large volumes of concurrent users. The system's architecture is also scalable, allowing it to support millions of users by simply adding additional server nodes or computing power.

The network (110) connecting the client device (102), the server (106), and the data repository (108) can employ both wired and wireless communication methods. For example, in mobile applications, communication may take place over cellular networks (e.g., 4G/5G), while in desktop or web applications, the communication may occur over wired Ethernet or Wi-Fi connections. In browser-based applications, additional security measures such as HTTP-only cookies may be used to store the dynamic token, preventing access to the token by malicious scripts (such as cross-site scripting (XSS) attacks). The system (100) can also mitigate cross-site request forgery (CSRF) risks by ensuring that every request is validated based on the token and the synchronized time window.

The system's (100) design supports various types of client-server architectures, including web applications, mobile applications, and browser-based applications. For web applications, the token generation and validation process may occur through a browser interface, where a token generator (1022) within the browser generates the dynamic token. The browser automatically sends the token to the server via HTTP requests, where it is validated by the server's token validation module. Similarly, in mobile applications, the client-side application generates the token through embedded logic within the app, and the token is transmitted to the server over HTTPS for validation. The system's flexibility allows it to seamlessly adapt to various application types while maintaining a high level of security and scalability.

In distributed computing environments, the server's processing tasks may be divided across multiple servers or virtual machines. These distributed components communicate over the network to collectively handle token validation, timing synchronization, and request processing. The system (100) can also leverage cloud computing infrastructure, where server resources are dynamically allocated based on demand, enabling scalability and high availability for large-scale applications.

The components involved in the invention, such as the client device's token generator (1022), the server's time server (112), and token validation module (1064), may be implemented using software, or hardware components or both. The server-side components can include dedicated processors or application-specific integrated circuits (ASICs) designed to handle the computational workload associated with token validation. Similarly, the data repository (108) may employ high-speed storage systems, such as SSD arrays or distributed database systems like Redis or Memcached, to ensure fast access to stored data and efficient handling of large volumes of authentication requests.

In this way, the architecture of FIG. 1 provides a comprehensive system (100) for secure, time-synchronized, stateless communication across a variety of applications. The client-server model depicted supports efficient, secure authentication through the use of dynamic tokens, ensuring that only legitimate, time-bound requests are processed. This system (100) offers scalability, flexibility, and robust security, making it suitable for use in mobile applications, web-based platforms, and distributed computing environments. By incorporating features such as time-slicing, token validation, and time synchronization, the invention provides a solution that addresses key security challenges in modern client-server communication architectures.

### Method of Operation:

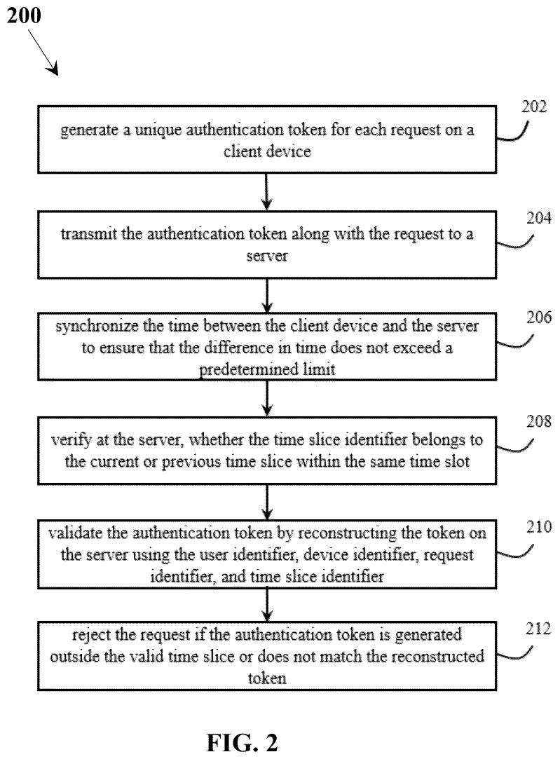

The present invention provides a computer-implemented method (200) for generating and validating time-based dynamic authentication tokens using a time-slicing approach for stateless client-server communication, as illustrated in FIG. 2. The method (200), outlined through steps (202) to (212), ensures that each request sent by a client device (102) to a server (106) is securely authenticated using a dynamic token (104), enhancing security in distributed and stateless environments.

Commencing with Step 202, the method (200) begins by generating a unique authentication token (104) for each request initiated by the client device (102). This authentication token is generated using a hash-based message authentication code (HMAC) method, incorporating the following parameters:
A user identifier, which uniquely identifies the user making the request. This identifier may be based on a secret key known only to the client and server, ensuring that only authorized users can generate valid tokens.
A device identifier, uniquely identifying the client device (e.g., MAC address or a random UUID). The device identifier ensures that tokens are specific to the user's device and cannot be reused by another device.
The current time, typically the current Unix time in milliseconds, ensures that tokens are valid only within a specific time window. The time must be synchronized between the client and server to ensure accurate validation.
A request identifier, uniquely identifying each request. This prevents tokens from being reused for different requests, adding a layer of security by binding each token to a specific transaction.
   The token is generated by applying the HMAC function on these parameters, producing a cryptographic hash that forms the dynamic token.

Once the token is generated, Step 204 involves transmitting the authentication token (104) along with the request to the server (106) over the network (110). As previously mentioned, the network (110) can be any wired or wireless communication system, including the Internet, local area networks (LANs), or wide area networks (WANs), enabling secure transmission between the client device (102) and the server (106). The transmission occurs using secure communication protocols, such as Transport Layer Security (TLS), which ensure that the data is encrypted and protected from interception during transit.

Step 206 focuses on time synchronization between the client device (102) and the server (106). This synchronization is vital because the time-slicing approach requires both the client and server to be operating within the same time frame to validate the token accurately. The time server (112) on the server ensures that the difference between the client and server time does not exceed a predetermined limit. For instance, this synchronization can be maintained with a time difference of 50 to 200 milliseconds, although this range is purely exemplary and not restrictive. The specific time tolerance depends on the application requirements and the level of security needed. For more sensitive applications, a tighter time window may be required, while less sensitive applications may allow for a broader tolerance.

Next, in Step 208, the server (106) verifies whether the time slice identifier in the received token (104) belongs to the current or previous time slice within the same time slot. The token validation module (1064) on the server plays a key role here, examining the time slice identifier and ensuring that the request falls within the predefined time window. If the time slice does not match the current or previous slice, the token may be flagged as expired or invalid, and the request is rejected to prevent replay attacks or unauthorized access attempts. The consideration window, which allows for the server to accept tokens from a previous slice, ensures that minor discrepancies in time synchronization do not result in legitimate requests being incorrectly rejected.

At Step 210, the server (106) performs the validation of the authentication token (104). This step involves reconstructing the token using the same elements—user identifier, device identifier, request identifier, and time slice identifier—that were used on the client side (102) during token generation. The server compares the reconstructed token with the token received from the client (102). If the tokens match and the request is within the valid time window, the request is authenticated and processed by the server (106). If there is a mismatch or the token falls outside the valid time slice, the request is rejected to prevent unauthorized access. This process ensures that each request is verified in real-time, providing a robust security mechanism.

In Step 212, the server (106) rejects any request if the authentication token (104) was generated outside the valid time slice or does not match the reconstructed token. This ensures that only legitimate requests—those generated within the valid time window and with a matching token—are processed. By rejecting invalid requests, the system ensures enhanced security and non-repudiation, preventing attackers from using outdated tokens or tokens generated on unauthorized devices.

In accordance with an embodiment of the present invention, the time-slicing method described above is flexible and can be tailored to different applications depending on security requirements. For example, the predetermined time slot duration can vary between 500 milliseconds and 300000 milliseconds, though this is only an exemplary range. The duration of the time slot can be adjusted based on the specific application, with shorter time slots providing higher security but requiring more precise synchronization, and longer slots allowing for greater tolerance in timing discrepancies.

Each time slot can be further divided into multiple slices, typically between 2 to 10 slices, each having a duration of 100 to 75000 milliseconds. Again, this range is exemplary and can be adjusted based on the needs of the system. For instance, in some embodiments, the time slot is divided into 4 slices, and the server validates tokens within the 4-slice window. This approach allows tokens generated in earlier slices to be validated in subsequent slices of the same time slot, increasing flexibility without compromising security.

In an embodiment where the system employs 4 slices, tokens generated in slice 1 (S1) of the current time slot can be validated across all four slices of the same time slot (S1 to S4). Similarly, tokens generated in slice 2 (S2) are valid across slices S2 to S4, and so on, until tokens generated in slice 3 (S3) are valid only in S3 and S4. This approach ensures that tokens are valid for short, precise time windows, reducing the risk of token reuse and increasing the system's resistance to timing-based attacks.

In some embodiments, the authentication tokens are generated using a hash-based message authentication code (HMAC). The HMAC is generated using the user identifier, device identifier, time slice identifier, and a secret key known to both the client (102) and the server (106). This cryptographic method ensures the authenticity of the request and prevents tampering with the token. The server (106) validates the HMAC token by reconstructing the token using the same parameters and comparing it to the token received from the client (102). This process ensures that the token was generated by an authorized user and has not been altered during transmission.

In accordance with an embodiment of the present invention, the system allows for flexibility in terms of the consideration window. In some embodiments, the server (106) may validate tokens from a previous time slice if they fall within a predefined consideration window (e.g., one time slice). This feature ensures that minor discrepancies in time synchronization between the client device (102) and the server (106) do not result in legitimate requests being rejected. This is particularly useful in environments where perfect synchronization is difficult to achieve, allowing the system to maintain a balance between security and usability.

In this manner, the method (200) described in FIG. 2 provides a comprehensive and secure approach to generating and validating time-synchronized dynamic authentication tokens. The system's ability to adapt time slot and time slice durations based on the application ensures flexibility, while the use of HMAC-based tokens and precise time-slicing adds robust security to stateless client-server communication. The method significantly reduces the risk of token reuse, replay attacks, and unauthorized access, making it a highly effective solution for a wide range of distributed and stateless environments.

Now, some of the above-mentioned exemplary scenarios are explained in details using figures and tables to show how the present invention operates in various real-world scenarios using dynamic time-sliced authentication tokens for stateless client-server communication. These scenarios demonstrate how tokens are validated across multiple time slices within predetermined time slots, accounting for different consideration windows and security requirements. The system adapts to varying time synchronization conditions between the client and server, ensuring secure validation of each request. Additionally, the invention incorporates mechanisms to detect and prevent potential security threats, such as device cloning or token misuse, thereby maintaining robust authentication across different devices and environments.

### Examples

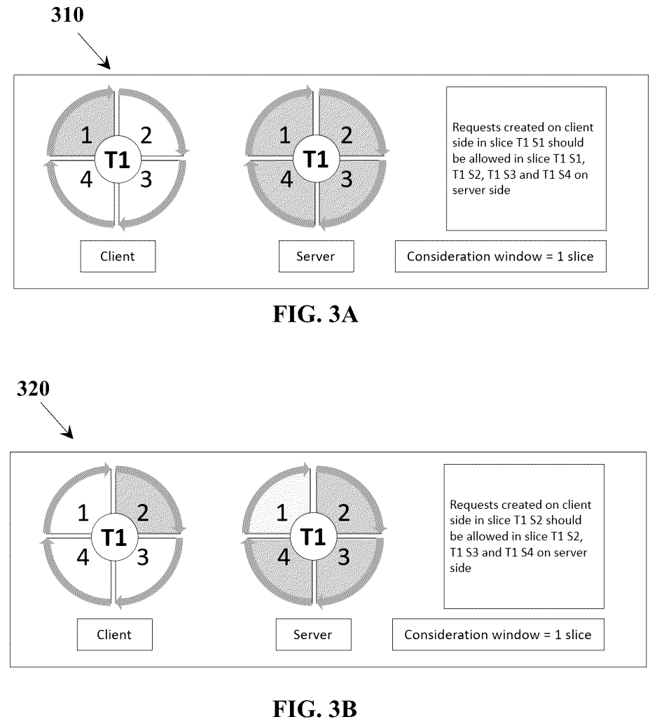

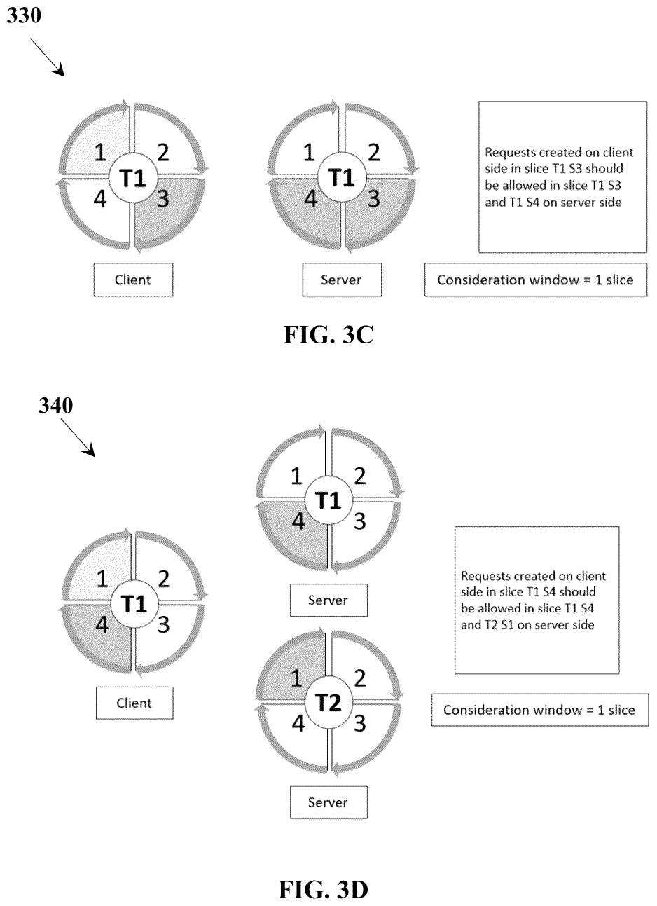

The present invention aims to solve the above problem of token expiring on time slot's border by further slicing of the above time slots in N number of parts and checking on the authenticator end as per the below logic:
1. If the request belongs to previous time slot and request creation time is before the consideration window, then the request should get rejected.
2. If the request belongs to previous time slot and request creation time is within the consideration window, then evaluate the token using previous time slot and the request should be allowed.
3. If the request belongs to current time slot, then evaluate the token using current time slot and the request should be allowed
4. If the request belongs to a future time slot, then the request should get rejected. This is possible when the source and destination both devices are out of sync in time
Proposed solution to address the above problem, considering 4 slices in each time slot and a consideration window of 1 slice: The FIGS. 3A-3D further explain the above scenarios considering 4 slices in each time slot and a consideration window of 1 slice.

### Dynamic One Tick Ahead Token Generation and Validation for Each Request:

In order to solve the above problems, this invention recommends creating new dynamic security token to be generated on client side and sent along with each request. This token is valid for a very short time slot (say 60 seconds) and prevents the chances to be reused by same or another user beyond the time elapsed. Similar token should be regenerated on server side using the same parameters as used on client side and matched for equality. If both tokens match, the request should be allowed and if tokens do not match, the request should be denied.

### Token Verification Using Time Slicing:

This invention recommends to split the time slot in 4 or more slices as previously agreed between client and server applications and append the time slice number to the end of the token.

So the token which reaches the server end has below format:

$$Token + Slice number$$

The table below explains the possible scenarios considering 4 slices in each time slot and a consideration window of 1 slice:

| Client side | Server side | | | |
|---|---|---|---|---|
| Time slice on | Time slice on | Request | | |
| authenticatee | authenticator | allowed or | Consideration | |
| side | side | rejected | Window | Explanation |
| T1 S1 | T1 S1 | OK | NA | Same time slot |
| T1 S1 | T1 S2 | OK | NA | Same time slot |
| T1 S2 | | | | |
| T1 S1 | T1 S3 | OK | NA | Same time slot |
| T1 S2 | | | | |
| T1 S3 | | | | |
| T1 S1 | T1 S4 | OK | NA | Same time slot |
| T1 S2 | | | | |
| T1 S3 | | | | |
| T1 S4 | | | | |
| T1 S1 | T2 S1 | Reject | 1 slice | T2 S1 > T1 S3 + CW |
| T1 S2 | | | | |
| T1 S3 | | | | |
| T1 S4 | T2 S1 | Consider OK | 1 slice | T2 S1 <= T1 S4 + CW |
| T1 S1 | T2 S2 | Reject | 1 slice | T2 S2 > T1 S4 + CW |
| T1 S2 | T2 S3 | | | |
| T1 S3 | T2 S4 | | | |
| T1 S4 | | | | |
| T10 S1 | T17 S1 | Reject | 1 slice | Network delay or |
| T10 S2 | T17 S2 | | | any other reason |
| T10 S3 | T17 S3 | | | |
| T10 S4 | T17 S4 | | | |
| T17 S1 | T10 S1 | Reject | 1 slice | Out of sync in time |
| T17 S2 | T10 S2 | | | |
| T17 S3 | T10 S3 | | | |
| T17 S4 | T10 S4 | | | |

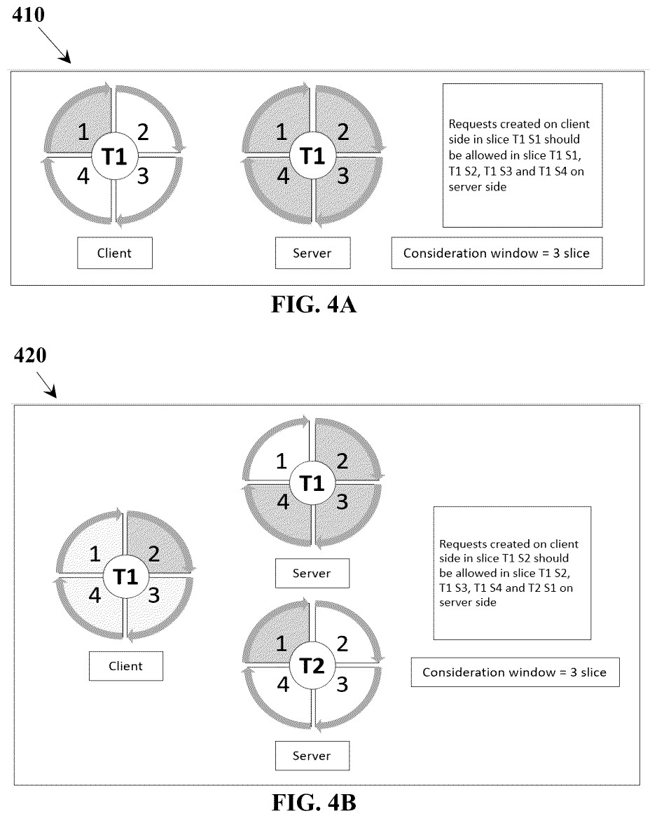

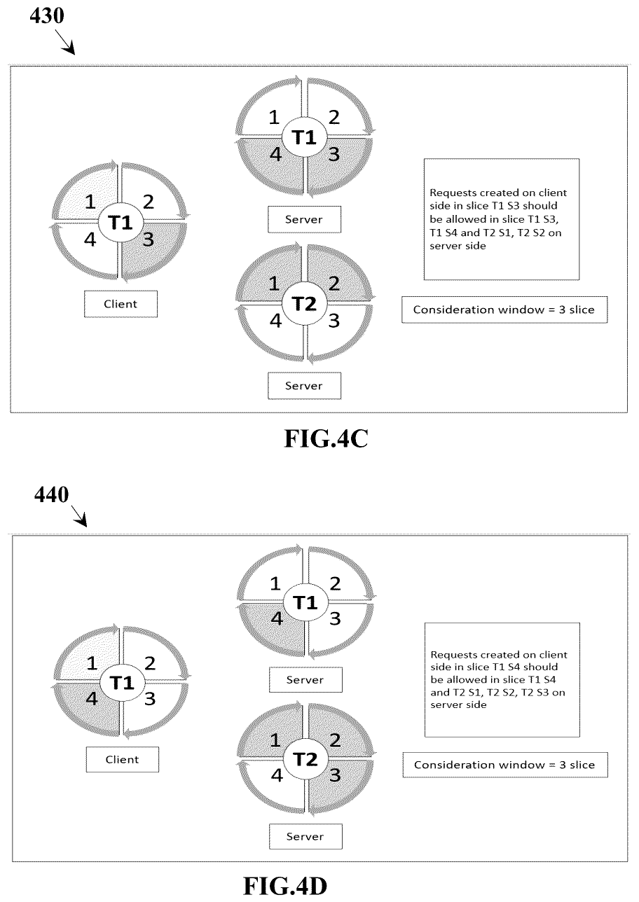

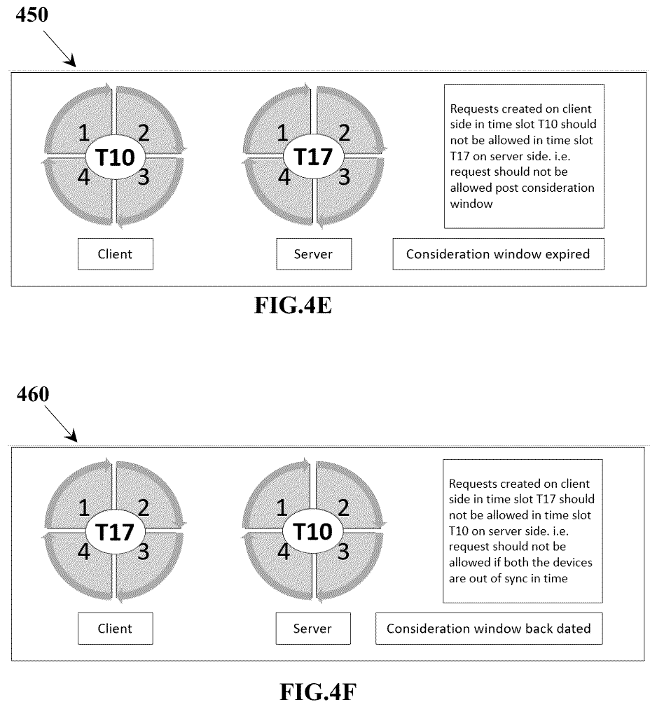

In the next example, the table below explains the possible scenarios considering 4 slices in each time slot and a consideration window of 3 slices: The FIGS. 4A-4F further explains the above scenarios considering 4 slices in each time slot and a consideration window of 3 slices.

| Client side | Server side | | | |
|---|---|---|---|---|
| Time slice on | Time slice on | Request | | |
| authenticatee | authenticator | allowed or | Consideration | |
| side | side | rejected | Window | Explanation |
| T1 S1 | T1 S1 | OK | 3 slices | Same time slot |
| | T1 S2 | | | |
| | T1 S3 | | | |
| | T1 S4 | | | |
| T1 S2 | T1 S2 | OK | 3 slices | T2 S1 <= T1 S2 + CW |
| | T1 S3 | | | |
| | T1 S4 | | | |
| | T2 S1 | | | |
| T1 S3 | T1 S3 | OK | 3 slices | T2 S2 <= T1 S3 + CW |
| | T1 S4 | | | |
| | T2 S1 | | | |
| | T2 S2 | | | |
| T1 S4 | T1 S4 | OK | 3 slices | T2 S3 <= T1 S4 + CW |
| | T2 S1 | | | |
| | T2 S2 | | | |
| | T2 S3 | | | |
| T1 S1 | T2 S1 | Reject | 3 slices | T2 S1 > T1 S1 + CW |
| | T2 S2 | | | |
| | T2 S3 | | | |
| | T2 S4 | | | |
| | . . . | | | |
| T1 S2 | T2 S2 | Reject | 3 slices | T2 S2 > T1 S2 + CW |
| | T2 S3 | | | |
| | T2 S4 | | | |
| | . . . | | | |
| T1 S3 | T2 S3 | Reject | 3 slices | T2 S3 > T1 S3 + CW |
| | T2 S4 | | | |
| | . . . | | | |
| T1 S4 | T2 S4 | Reject | 3 slices | T2 S4 > T1 S4 + CW |
| | . . . | | | |
| T10 S1 | T17 S1 | Reject | 3 slices | Network delay or |
| T10 S2 | T17 S2 | | | any other reason |
| T10 S3 | T17 S3 | | | |
| T10 S4 | T17 S4 | | | |
| T17 S1 | T10 S1 | Reject | 3 slices | Out of sync |
| T17 S2 | T10 S2 | | | |
| T17 S3 | T10 S3 | | | |
| T17 S4 | T10 S4 | | | |

Now, the following table illustrates few examples of HMAC tokens with time slicing:

On client side

| | Current | |
|---|---|---|
| HMAC created | time slice | Token to be sent with request |
| 44a01177a967f94a724adf966 | S1 | 44a01177a967f94a724adf966 |
| bfe3a36 | | bfe3a36-S1 |
| f4420857a50cf152450ded031 | S2 | f4420857a50cf152450ded031 |
| af900c7 | | af900c7-S2 |
| b71fac7d52c3fed94353c677d | S3 | b71fac7d52c3fed94353c677d |
| 54dbf3b | | 54dbf3b-S3 |
| c4c90a6bbe8e3ff9780042723 | S4 | c4c90a6bbe8e3ff9780042723 |
| d36b750 | | d36b750-S4 |

Following table illustrates token verification process at server side

On server side

| Token received from | Current Slice | Time slot | |
|---|---|---|---|
| client | on server | consideration | Result |
| 44a01177a967f94a72 | S1 | Current | Allowed if token created in |
| 4adf966bfe3a36-S1 | S2 | time slot | current time slot, else denied |
| | S3 | | |
| | S4 | | |
| f4420857a50cf15245 | S1 | Previous | Allowed if token created in |
| 0ded031af900c7-S2 | | time slot | previous time slot, else denied |
| | S2 | Current | Allowed if token created in |
| | S3 | time slot | current time slot, else denied |
| | S4 | | |
| b71fac7d52c3fed943 | S1 | Previous | Allowed if token created in |
| 53c677d54dbf3b-S3 | S2 | time slot | previous time slot, else denied |
| | S3 | Current | Allowed if token created in |
| | S4 | time slot | current time slot, else denied |
| c4c90a6bbe8e3ff9780 | S1 | Previous | Allowed if token created in |
| 042723d36b750-S4 | S2 | time slot | previous time slot, else denied |
| | S3 | | |
| | S4 | Current | Allowed if token created in |
| | | time slot | current time slot, else denied |

### Example of Time-based HMAC Token Validation Process

Let's explore a real-world example of how the proposed HMAC generation and validation method works in practice:

Consider a client device attempting to send a request to a server in a system where the time slot duration is 60 seconds, and each time slot is divided into 4 slices (each slice is 15 seconds). The HMAC token is generated based on the user identifier, device identifier, current time, and request identifier, as shown in the table below.

### Token Generation on Client Side:

User identifier: A secret key, jSSwvUwdlkzIJeQiOc5UVtNl+rxLz31dEcx8DgwjH70 W
Device identifier: MAC address, C1:73:95:62:81:A3
Current time: 1723891133032 ms (Aug. 17, 2024, 16:08:53 IST)
Time slice: S4 (the last 15 seconds of the time slot)
Request identifier: 303e4c8c1 fc85c2a12bf3093aa8f98e3

The client device generates a token by concatenating the device identifier, time slice, and request identifier, and then applying the HMAC function using the secret key.

The final token is: 887b97ab7521d8a7ef5cb38cb365063dc4d18d8c7dfa912956ae4b0214048845b0e6ed453cefd effe85cf60640d6bbb71f64ee4c7ae39a6d95cd271ecfcb06fd-S4

### Token Validation on Server Side:

The server receives the token and checks the time slice. The server's current time is 1723891152808 ms (Aug. 17, 2024, 16:09:12 jST), meaning the server is in the next time slot (51 of the new slot).
Since the token was generated in the previous time slice (S4), the server checks whether it falls within the consideration window. In this case, the system allows validation for one previous slice.
The server regenerates the token using the same user identifier, device identifier, and request identifier. If the reconstructed token matches the one received from the client, the request is allowed.

This ensures that the request is processed securely and only valid within the allowed time slices.

| | Source | Destination |
|---|---|---|
| Secret key | jSSwvUwdlkzIJeQiOc5UVtNl + | jSSwvUwdlkzIJeQiOc5UVtNl + |
| | rxLz31dEcx8DgwjH70W | rxLz31dEcx8DgwjH70W |
| Source MAC | C1:73:95:62:81:A3 | C1:73:95:62:81:A3 |
| Address | | |
| Current time | 1723891133032 | 1723891152808 |
| (milliseconds) | | |
| Current time | 17 Aug. 2024 16:08:53 IST | 17 Aug. 2024 16:09:12 IST |
| Time slice | (T1) S4 | (T2) S1 |
| (S1/S2/S3/S4) | | |
| Time slot duration | 60000 | 60000 |
| (milliseconds) | | |
| Current time slot | 28731518 | 28731519 |
| Previous time slot | 28731517 | 28731518 |
| Request Id | 303e4c8c1fc85c2a12bf3093aa8f98 | 303e4c8c1fc85c2a12bf3093aa8f98 |
| | e3 | e3 |
| Generated string | C1:73:95:62:81:A3 \| 28731518 \| | C1:73:95:62:81:A3 \| 28731518 \| |
| | 303e4c8c1fc85c2a12bf3093aa8f98 | 303e4c8c1fc85c2a12bf3093aa8f98 |
| | e3 | e3 |
| Generated token | 887b97ab7521d8a7ef5cb38cb3650 | 887b97ab7521d8a7ef5cb38cb3650 |
| (SHA512) | 63dc4d18d8c7dfa912956ae4b0214 | 63dc4d18d8c7dfa912956ae4b0214 |
| | 048845b0e6ed453cefdeffe85cf606 | 048845b0e6ed453cefdeffe85cf606 |
| | 40d6bbb71f64ee4c7ae39a6d95cd2 | 40d6bbb71f64ee4c7ae39a6d95cd2 |
| | 71ecfcb06fd | 71ecfcb06fd |

Token matches, request allowed

| | | |
|---|---|---|
| Final token | 887b97ab7521d8a7ef5cb38cb3650 | Based on S4 from source side and |
| | 63dc4d18d8c7dfa912956ae4b0214 | S1 on destination side, we learn |
| | 048845b0e6ed453cefdeffe85cf606 | that the token belongs to the |
| | 40d6bbb71f64ee4c7ae39a6d95cd2 | previous time slot |
| | 71ecfcb06fd-S4 | |

Following table illustrates an example where the tokens generated by source and destination applications do not match with each other and hence the request is denied

| | Source | Destination |
|---|---|---|
| Secret key | jSSwvUwdlkzIJeQiOc5UVtNl + | jSSwvUwdlkzIJeQiOc5UVtNl + |
| | rxLz31dEcx8DgwjH70W | rxLz31dEcx8DgwjH70W |
| Source MAC | C1:73:95:62:81:A3 | C1:73:95:62:81:A3 |
| Address | | |
| Current time | 1723891133032 | 1723892682866 |
| (milliseconds) | | |
| Current time | 17 Aug. 2024 16:08:53 IST | 17 Aug. 2024 16:34:42 IST |
| Time slice | (T1) S4 | (T10) S3 |
| (S1/S2/S3/S4) | | |
| Time slot duration | 60000 | 60000 |
| (milliseconds) | | |
| Current time slot | 28731518 | 28731544 |
| Previous time slot | 28731517 | 28731543 |
| Request Id | 303e4c8c1fc85c2a12bf3093aa8f98 | 303e4c8c1fc85c2a12bf3093aa8f98 |
| | e3 | e3 |
| Generated string | C1:73:95:62:81:A3 \| 28731518 \| | C1:73:95:62:81:A3 \| 28731543 \| |
| | 303e4c8c1fc85c2a12bf3093aa8f98 | 303e4c8c1fc85c2a12bf3093aa8f98 |
| | e3 | e3 |
| Generated token | 887b97ab7521d8a7ef5cb38cb3650 | eed12a4f2f8db6a4cfdcf708b564ba |
| (SHA512) | 63dc4d18d8c7dfa912956ae4b0214 | 983f8641321d86645aa421e8e392c |
| | 048845b0e6ed453cefdeffe85cf606 | b618d1b6f02930d8133b9ef6661b1 |
| | 40d6bbb71f64ee4c7ae39a6d95cd2 | f8aea4e99edede97431ab8e53203de |
| | 71ecfcb06fd | b09f5ae7b9 |

Token mismatch, request denied

| | | |
|---|---|---|
| Final token | 887b97ab7521d8a7ef5cb38cb3650 | Based on S4 from source side and |
| | 63dc4d18d8c7dfa912956ae4b0214 | S3 on destination side, we learn |
| | 048845b0e6ed453cefdeffe85cf606 | that the token belongs to the |
| | 40d6bbb71f64ee4c7ae39a6d95cd2 | previous time slot but since lot of |
| | 71ecfcb06fd-S4 | time elapsed, hence request |
| | | rejected |

### Embodiment for Detecting Cloned Devices Using the Present Invention:

In an embodiment of the present invention, a mechanism is introduced to detect potential device cloning based on tracking the sequence of requests sent by the client application. The goal of this embodiment is to provide basic protection against the risk of device cloning, ensuring that cloned devices cannot successfully replicate the actions of a genuine client. By implementing this check, the system can detect whether the request sequence aligns with what is expected from the legitimate client, thereby identifying suspicious behavior indicative of device cloning.

In this embodiment, a simple check is introduced on server side to attempt to check if the client device is cloned. Intent here is to recommend a very basic protection against device cloning.

This invention recommends the client application generate a unique request id for each request including the login and logout requests and to keep a thread safe ordered list of generated request id's corresponding to last few (say last 50 or last 100) server side APIs invoked. The list should be updated before making a call to server API. In case of retry, either the list should be added with the same request id or a counter could be updated for each retry. If the client application is multithreaded, it should be mandated to keep the list in order by using appropriate thread safety measures on client side. Client application should send this list of request id's including the current request id while invoking the server API.

The server application should implement a policy which entitles and enables the server application to either reject or conditionally accept new API requests from a client application which is previously detected or suspected to be cloned.

Corresponding to every client application identifier, the server application should keep an ordered list of last few request id's (say 50 or 100 as appropriate) corresponding to the requests sent by the client applications. Considering replicated deployment of server APIs and possibly multiple instances of deployed server applications, creation of this list of request id's should be a responsibility of the client application. Such lists could be stored in faster server side cache e.g. Redis or Memcached etc. This list of request id's could safely be deleted or logged for future reference once session of client application gets terminated or a logoff happens.

The server application should store the list of request id's corresponding to every client application's identifier (say session id) and check the list for correctness of sequence mentioned in client's request upto the last request by the client application. If the sequence mentioned by client application does not match with the sequence stored on server, the session should immediately be terminated and next attempt to initialize a session or invoke another request should be handled according to the policy.

The server application should expose a keep alive API which could be invoked by the client application. This should be a dummy API which does not change the state on the server side and does not return any data. If the client application is active, then it is not expected to send keep alive but if the client application goes idle, it is then expected to periodically keep sending a keep alive request on a very short span of time. If a keep alive message is not arrived for a few cycles, the client session should be terminated. This keep alive request should also include a request id and also include the list of last few request id's including the current request's request id.

The catch here is that the purpose of hacker to clone the application is either to steal information or to make some transaction on genuine user's behalf In order to achieve this purpose, the hacker must invoke some API on the server. Even if the hacker's application is idle, it will still send the keep alive message.

Considering a client's application is cloned using device cloning, then the secret key and device identifier are also expected to be stolen and the request coming from such a cloned application is expected to be similar to the request coming from a genuine application.

If the sequence of request id's in list of last few requests sent by client application does not match with the sequence stored at the server, the session should be immediately terminated without serving the request and the incident should be reported to the intrusion detection team.

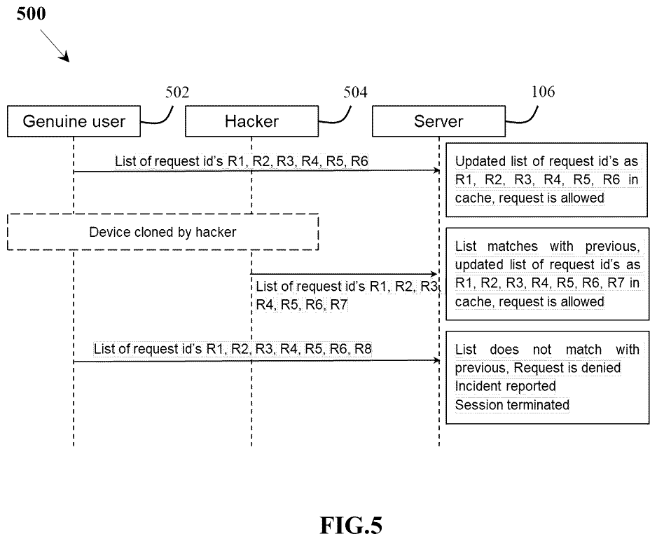

FIG. 5 illustrates an exemplary information flow (500) of the system (100) of FIG. 1 to detect device cloning, in accordance with an embodiment of the present invention. The FIG. 5 demonstrates an exemplary scenario where the server (106) detects a cloned device based on mismatched request identifiers. In this scenario, the genuine user (502) and a hacker (504) (who has cloned the genuine user's) are both attempting to communicate with the server (106) using the same device identifier and secret key, but with different request identifiers.

1. Initial Requests from the Genuine User (502):
The genuine user (502) initially sends requests with the identifiers R1, R2, R3, R4, R5, and R6 to the server (106). These requests are accepted, and the server (106) maintains an updated list of request IDs in its cache, with the latest entry being R6.
The server (106) checks the sequence of incoming request identifiers from the client device and finds that they match the previously received identifiers (R1 to R6). Since the sequence is valid, the server (106) updates the list in its cache with the new request identifier R6 and allows the request.

### 2. Hacker's (504) Cloned Device:

The hacker (504), using a cloned version of the genuine user's, begins sending requests with a different sequence of request identifiers: R4, R5, R6, and R7.
Since the hacker (504) has cloned the device, they may attempt to access the server (106) using a seemingly legitimate device identifier and secret key. The server (106) receives the list of request IDs (R4 to R7) from the cloned device and compares it to the list stored in its cache.
The server (106) checks the sequence and finds that the request identifiers match the last few valid requests (from R4 to R6) in its cache. Therefore, the server (106) updates the list of request IDs in the cache to include R7, assuming the sequence is valid, and allows the request.

### 3. Conflict Between Genuine User (502) and Hacker (504):

After the hacker's request, the genuine user (502) continues interacting with the server (106) by sending requests with R7 and R8.
However, the server (106), which now has R7 in its cache (due to the hacker (504)'s cloned device), receives a list of request IDs (R1 to R6 followed by R8) from the genuine user (502). The server (106) detects a mismatch in the sequence because the last valid request ID stored in the server (106)'s cache is R7, but the genuine user (502)'s request contains R8, skipping R7 in the sequence.
As a result, the server (106) immediately detects the mismatch and flags the session as compromised. The server (106) denies the request, reports the incident to the intrusion detection system, and terminates the session to prevent further communication from both the genuine user (502) and the cloned device.

### 4. Conclusion:

This detection mechanism effectively identifies the cloning attempt by verifying the sequence of request IDs. The mismatch in the sequence between the genuine user (502)'s requests and the hacker's cloned device requests allows the server (106) to detect the cloning incident and take appropriate action.

### Time-Bounding of Client Applications

In another embodiment of the present invention, the server-side logic is designed to monitor and enforce time intervals between the invocation of important application programming interfaces (APIs) by client applications. This is essential because genuine users are expected to exhibit natural pauses between invoking significant APIs, such as viewing account balances followed by performing a transaction, which typically requires a minimum time gap, for example, 3-4 seconds, to review the account balance screen.

Given that client applications are often multithreaded, and many modern server infrastructures employ a microservice architecture, there is the potential for a large volume of requests to be generated within very short time intervals. Servers handling such requests may often disregard the natural time gaps between invoking essential APIs, increasing the risk of abuse by automated scripts or malicious actors attempting to circumvent standard user behavior patterns.

To address this issue, the present invention proposes bounding client applications to follow specific time gaps between API invocations. In this embodiment, the server application enforces a rule that mandates the invocation of certain prerequisite APIs before others, and also maintains a record of each API invocation, including timestamps associated with each request.

### Example Data Structure for Time-Bounding

The table illustrated above demonstrates the structure for tracking client interactions. For each client ID, a list of request IDs corresponding to API invocations is maintained along with the associated timestamps.

For instance, the table includes three clients:
Client ID 388489069, who has invoked requests R11 through R19 corresponding to APIs A1 through A9 with timestamps TS11 through TS19.
Client ID 616286715, who has invoked requests R21 through R29 corresponding to APIs A1 through A9 with timestamps TS21 through TS29.
Client ID 551807608, who has invoked requests R31 through R39 corresponding to APIs A1 through A9 with timestamps TS31 through TS39.

This data is stored in the server's cache in JSON format. For example, for client ID 388489069, the following JSON object may be stored:

{
R11: { requestid: R11, api: A1, timestamp: TS11 },
R12: { requestid: R12, api: A2, timestamp: TS12 },
R13: { requestid: R13, api: A3, timestamp: TS13 },
R14: { requestid: R14, api: A4, timestamp: TS14 },
R15: { requestid: R15, api: A5, timestamp: TS15 },
R16: { requestid: R16, api: A6, timestamp: TS16 },
R17: { requestid: R17, api: A7, timestamp: TS17 },
R18: { requestid: R18, api: A8, timestamp: TS18 },
R19: { requestid: R19, api: A9, timestamp: TS19 }
}

In this embodiment, the server tracks the sequence of API invocations, including the timestamps associated with each request. For instance, if API A7 has A5 and A3 as mandatory prerequisite APIs, and the required time delay between invoking A3, A5, and A7 is set to 2 seconds, the system ensures that the sequence and timing constraints are strictly followed.

If the client's request does not respect the established API invocation order or the time gaps between the timestamps—such as a gap between TS13 and TS15 or TS15 and TS17 being less than 2 seconds—the system will deny the request and terminate the session. This prevents automated scripts or malicious actors from invoking sensitive APIs in quick succession, ensuring that user actions adhere to expected human behavior patterns.

This embodiment strengthens the overall security of the system by introducing an additional verification layer, ensuring that API invocations follow a logical sequence and natural timing intervals, which are difficult for automated scripts to mimic accurately.

The present invention offers recommendations on an “as is” basis for implementing application-layer security. These recommendations do not guarantee foolproof protection or immunity from intrusion or fraud. In the event of a successful attack or breach following the implementation of these recommendations, the authors of this invention assume no liability for any losses or inconvenience incurred. Implementors are advised to exercise due diligence and assess the suitability of these recommendations for their specific use cases.

It is important to note that any request generated by the client and received by the server after the current time slot and consideration window will be rejected. If a longer window for consideration is required, it is advisable to select a longer time slot duration to accommodate such scenarios.

Terms such as “authenticator” and “authenticatee,” “source device” and “destination device,” “sender” and “receiver,” and “client” and “server” are used interchangeably throughout the specification to denote the sender and receiver of requests or messages.

The present invention addresses one of the critical issues in web application security by introducing a time-based dynamic authentication token mechanism. While additional security measures such as OTP (One-Time Password) and CAPTCHA may still be necessary, the manual steps traditionally involved in request authentication can be significantly reduced or eliminated using the recommended approach. The time-based token, previously limited to login sessions, can now be applied to every client request, enhancing security throughout the communication session.

This token ensures that each request is authenticated individually and cannot be reused by the same or a different user, whether on the same or a different device. It also restricts the use of external REST clients, such as Postman, to invoke APIs, thereby preventing misuse. Additionally, it protects against the exploitation of automated scripts that could attempt to breach the system.

Furthermore, the proposed solution mitigates the risk of man-in-the-middle (MITM) attacks, as a token that has been used once cannot be reused for any other request by any other user on any other device. The dynamic nature of the tokens ensures that attackers cannot generate fresh tokens without access to the secret key and other essential parameters, which are difficult to replicate.

The invention also extends protection against device cloning, providing a fundamental but effective solution to detect cloned devices attempting to replicate genuine user activity. While more sophisticated approaches may be developed in the future, this method is capable of detecting and thwarting many of today's fraudulent activities.

The present invention offers several significant advantages, making it highly effective for ensuring secure, time-based, stateless client-server communication. Some of the key advantages include:
Enhanced Security through Time-Sliced Authentication Tokens: The invention introduces a dynamic, time-sliced authentication mechanism that ensures each request is associated with a unique token, valid only within a specific time window. By incorporating time slices within predefined time slots, the system significantly reduces the risk of token reuse or replay attacks. The use of HMAC-based tokens ensures that only legitimate users and devices can generate and validate tokens, enhancing overall system security.
Stateless Client-Server Communication: The invention operates effectively in stateless environments, where the server does not need to maintain session states for each client request. By dynamically generating and validating tokens using time synchronization and request-specific parameters, the system eliminates the need for continuous session tracking, allowing for greater scalability and reduced server resource consumption.
Resistance to Device Cloning Attacks: The invention incorporates a method to detect device cloning, providing an added layer of security. By tracking the sequence of request identifiers and comparing the client's list of recent requests with the server's stored list, the system can identify discrepancies that signal cloned devices attempting to interact with the server. This feature ensures that cloned devices are detected and blocked from accessing the system, preventing unauthorized actions.
Protection against Unauthorized Access: The invention ensures that tokens are request-specific, device-specific, and time-bound, making it nearly impossible for hackers to reuse stolen or copied tokens. Each token is generated using unique parameters such as the user identifier, device identifier, and request identifier, which guarantees that even if a token is intercepted, it cannot be reused by unauthorized devices or users.
Adaptability and Flexibility: The invention is adaptable to various time-sensitive applications by allowing customizable time slot durations and time slice windows. The consideration window can be adjusted based on the level of security required, ensuring that legitimate requests are not inadvertently rejected due to minor time discrepancies while maintaining strict validation for sensitive applications. The system can also be implemented in both mobile and web-based applications, ensuring wide applicability.
Efficient Detection of Intrusion Attempts: By incorporating mechanisms such as the keep-alive API and session tracking based on request sequences, the system provides efficient methods for detecting intrusion attempts. The server can identify abnormal behavior patterns or idle sessions, terminating them before they are exploited by malicious users or hackers.
Minimal Overhead with High Scalability: The time-based token generation and validation process is lightweight and requires minimal server resources, making it highly scalable. This allows the system to handle a large number of concurrent users and requests without compromising performance or security, making it ideal for modern distributed systems that demand efficiency and flexibility.
Non-Repudiation and Accountability: The system ensures non-repudiation, as each token is uniquely tied to a specific user, device, and request. This makes it impossible for users to deny actions once tokens are generated and validated, providing a robust audit trail and ensuring accountability for all actions performed within the system.
Versatility Across Platforms: The invention is applicable to various platforms, including web applications, mobile applications, and browser-based applications. This makes the security framework versatile and capable of integrating with different types of client-server communication environments.
Real-Time Synchronization: The use of synchronized time between the client and server, with allowances for minor discrepancies, ensures real-time validation of tokens without introducing significant overhead. The system efficiently handles slight timing variations, allowing for smooth and secure communication.

In general, the word “module,” as used herein, refers to logic embodied in hardware or firmware, or to a collection of software instructions, written in a programming language, such as, for example, python R, C, C#, Java, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices, or entities, the operations may be performed by or otherwise related to any module, device, or entity. As such, any function or operation that has been described as being performed by a module could alternatively be performed by a different server, by the cloud computing platform, or a combination thereof.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and the appended claims.

We claim:

1. A system for generating and validating time-based dynamic authentication tokens using a time-slicing approach for stateless client-server communication, comprising:
a client device, configured to:
generate a unique authentication token for each request, the authentication token comprising:
a user identifier representing the identity of the user;
a device identifier uniquely identifying the client device;
a request identifier uniquely identifying the request being transmitted; and
a time slice identifier corresponding to a portion of a predetermined time slot divided into multiple slices;
transmit said authentication token along with the request during a valid time slice;
a server connected with the client device via a network;
a time server time server, for synchronizing the server time with the client device time and maintaining the time slices to ensure that the difference between the current time on the client device and the server does not exceed a predetermined time limit;
wherein the server comprising
a token validation module, configured to:
receive the request and the authentication token from the client device;
determine whether the time slice identifier belongs to the current or previous time slice within the same time slot or falls within a predefined consideration window;
validate the authentication token by reconstructing the token using the user identifier, device identifier, request identifier, and time slice identifier;
reject the request if the authentication token is generated outside the valid time slice or does not match the reconstructed token, or process the request if the authentication token matches the reconstructed token, thereby providing enhanced security for stateless communication and non-repudiation.

2. The system of claim 1, wherein the synchronization between the client device and the server ensures that the difference between the Unix time on both devices does not exceed 50 to 200 milliseconds.

3. The system of claim 1, wherein the predetermined time slot duration is between 500 to 300000 milliseconds.

4. The system of claim 1, wherein the predetermined time slot is divided into 2 to 10 time slices, with each slice having a duration between 100 to 75000 milliseconds.

5. The system of claim 1, wherein the authentication token generated for a request is valid only within the predetermined time slot and expires upon the completion of the time slot.

6. The system of claim 1, wherein the token validation module allows tokens generated in the previous time slots if they fall within a predefined consideration window of 1 to (n−1) time slice, wherein ‘n’ is number of slices in one slot.

7. The system of claim 1, wherein the time slot is divided into exactly 4 slices, and the token validation module is configured to validate tokens using a 4-slice window, allowing tokens from any of the slices in the current or previous time slot within the consideration window.

8. The system of claim 7, wherein the token validation module is further configured to:
validate tokens by accepting those generated in slice 1 within the current time slot in slices 1 through 4 (S1, S2, S3, S4) of the current time slot on the server side;
validate tokens generated in slice 2 (S2) within slices 2 through 4 of the current time slot and slice 1 of next time slot; and
validate tokens generated in slice 3 (S3) within slices 3 and 4 of the current time slot and slice 1 and 2 of next time slot.

9. The system of claim 1, wherein the authentication token comprises a hash-based message authentication code (HMAC) or equivalent, generated by a token generator using any one or more of the user identifier, device identifier, request identifier, time slice identifier, and a static or dynamic secret key.

10. The system of claim 9, wherein the server validates the HMAC token by comparing the user identifier, device identifier, request identifier, and time slice identifier with the secret key.

11. A method for generating and validating time-based dynamic authentication tokens using a time-slicing approach for stateless client-server communication, comprising:
generating a unique authentication token for each request on a client device, wherein the token comprises:
a user identifier representing the identity of the user;
a device identifier uniquely identifying the client device;
a request identifier uniquely identifying the request being transmitted;
a time slice identifier corresponding to a portion of a predetermined time slot divided into multiple slices;
transmitting the authentication token along with the request to a server;
synchronizing a time between the client device and the server to ensure that the difference in time does not exceed a predetermined limit;
determining, at the server, whether the time slice identifier belongs to the current or previous time slice within the same time slot or falls within a predefined consideration window;
validating the authentication token by reconstructing the token on the server using the user identifier, device identifier, request identifier, and time slice identifier;
rejecting the request if the authentication token is generated outside the valid time slice or does not match the reconstructed token or process the request if the authentication token matches the reconstructed token, thereby ensuring enhanced security and non-repudiation.

12. The method of claim 11, further comprising the step of synchronizing the time between the client device and the server to ensure that the difference in Unix time between the client device and server does not exceed 50 to 200 milliseconds.

13. The method of claim 11, wherein the time slot duration is predetermined to be between 500 to 300000 milliseconds.

14. The method of claim 11, wherein the predetermined time slot is divided into 2 to 10 time slices, with each slice having a duration between 100 to 75000 milliseconds.

15. The method of claim 11, wherein the authentication token is valid only within the predetermined time slot and expires upon the completion of the time slot.

16. The method of claim 11, wherein the server validates tokens generated in the previous time slice if they fall within a predefined consideration window of 1 to (n−1) time slice, wherein ‘n’ is number of slices in one slot.

17. The method of claim 11, wherein the time slot is divided into exactly 4 slices, and the server validates tokens using a 4-slice window, allowing tokens from any of the slices in the current or previous time slot within the consideration window.

18. The method of claim 17, further comprising the steps of:
validating tokens generated in slice 1 (S1) within the current time slot in slices 1 through 4 (S1, S2, S3, S4) of the current time slot on the server;
validating tokens generated in slice 2 (S2) within slices 2 through 4 of the current time slot and slice 1 of next time slot; and
validating tokens generated in slice 3 (S3) within slices 3 and 4 of the current time slot and slice 1 and 2 of next time slot.

19. The method of claim 11, wherein the authentication token is generated using a hash-based message authentication code (HMAC) or equivalent, based on the user identifier, device identifier, time slice identifier, request identifier and a secret key.

20. The method of claim 19, wherein the step of validating the HMAC token on the server includes comparing the user identifier, device identifier, request identifier, and time slice identifier with the secret key.
